(19) United States
(12) Patent Application Publication
(10) Pub. No.: US 2026/0139950 A1
(43) Pub. Date: May 21, 2026

(54) HYBRID INDOOR POSITIONING SYSTEMS AND METHODS THEREOF

(71) Applicant: MappedIn Inc., Waterloo (CA)

(72) Inventors: Erkang Wei, Waterloo (CA); Katie McConnell, Fernie (CA); Andrew Cherry, Kitchener (CA); Robert Popiolek, Windsor (CA); Yuval Kossovsky, Pittsburgh, PA (US)

(21) Appl. No.: 19/388,134

(22) Filed: Nov. 13, 2025

Related U.S. Application Data
(60) Provisional application No. 63/721,009, filed on Nov. 15, 2024.

(51) Int. Cl. G01C 21/20

(52) U.S. Cl. CPC G01C 21/206

(57) ABSTRACT

Provided are systems and methods for hybrid indoor positioning. A system comprises a processor(s) and a memory(ies) having stored thereon instructions to perform receiving, through a graphical user interface of a user device, a request for determining a location of the user device within a facility, determining, by an indoor positioning system (IPS), an IPS location of the user device, displaying the IPS location on the graphical user interface, determining a level of accuracy of the IPS location, and when the level of accuracy is not adequate, determining, by a visual positioning system, a VPS location of the user device within the facility, adjusting the IPS location to a VPS-adjusted IPS location, and displaying the VPS-adjusted IPS location on the graphical user interface, and when the level of accuracy is adequate, continuing to monitor the level of accuracy.

### TECHNICAL FIELD

The embodiments disclosed herein relate to indoor wayfinding, and, in particular to systems and methods for accurate wayfinding in indoor spaces.

### INTRODUCTION

Indoor wayfinding requires accurate indoor positioning. There are currently two well known systems for providing indoor positioning for a wayfinding system: an indoor positioning system (IPS) and a visual positioning system (VPS). IPS uses various sensor technologies including global positioning satellites (GPS), Wi-Fi, Bluetooth™, gyroscopes, compasses, etc., to locate a device within an indoor space. VPS matches visual features from presently acquired images to previously acquired images or other data for an indoor location to determine the location where the images were acquired.

The two systems have advantages and disadvantages. IPS can provide longitude and latitude but lacks precision in open areas and multi-story areas, and is often accurate between 3-30 meters. That is, IPS may provide an accurate location based on latitude and longitude but the location may be on the wrong floor. IPS can only provide a heading, i.e., the direction a user is facing, via a compass, but compasses are prone to error due to interference. VPS provides accurate measurements to a few meters and can provide a heading but can only provide real-time information if a user is continuously providing images of their surroundings, meaning the user would need to have their camera on at all times. This would lead to severe battery drain and a poor user experience (UX) of holding their device up constantly.

In known methods VPS has been combined with outdoor positioning and with AR frameworks.

Accordingly, there is a need for systems and methods which allow for accurate indoor positioning without the disadvantages listed above by combining IPS and VPS for real-time accurate positioning.

### SUMMARY

Provided is a system for hybrid indoor positioning, including at least one processor and at least one memory having stored thereon instructions that, upon execution, cause the system to perform functions comprising: receiving, through a graphical user interface of a user device, a request for determining a location of the user device within a facility, determining, by an indoor positioning system (IPS), an IPS location of the user device within the facility, wherein the IPS receives a map of the facility from the at least one memory, displaying the IPS location on the graphical user interface, determining a level of accuracy of the IPS location, and when the level of accuracy is not adequate, determining, by a visual positioning system (VPS), a VPS location of the user device within the facility, adjusting the IPS location to a VPS-adjusted IPS location, and displaying the VPS-adjusted IPS location on the graphical user interface, and when the level of accuracy is adequate, continuing to monitor the level of accuracy.

The VPS may determine the VPS location of the user device using a camera on the user device.

The user device may further request directions to a destination within the facility, wherein the IPS provides directions to the destination, and wherein the directions are adjusted when a VPS location is determined.

A real-time location of the user device may be monitored by the IPS and displayed on the graphical user interface, wherein the IPS location continues to be adjusted based on the VPS location until a state change is identified.

The state change may comprise a change of floor level.

The change of floor level may be determined by at least one of tracking changes in altitude, detecting that the user device moved through a floor change connection, and receiving a new floor level value from the IPS.

When a state change is identified the VPS location is cleared and the VPS-adjusted IPS location reverts to the IPS location determined solely by the IPS.

The level of accuracy may be determined based on at least one of a calculated accuracy distance of the IPS location, an unknown status of a floor level for the IPS location, or the IPS location being in an area with known accuracy issues.

The known accuracy issues may be determined from analysis of test data.

The IPS location may be displayed on the graphical user interface as an IPS icon.

The VPS location may be displayed on the graphical user interface as a VPS icon.

The IPS may provide a heading using a compass.

The VPS may provide a heading.

Provided is a method for hybrid indoor positioning, comprising receiving, through a graphical user interface of a user device, a request for determining a location of the user device within a facility, determining, by an indoor positioning system (IPS), an IPS location of the user device within the facility, wherein the IPS receives a map of the facility from the at least one memory, displaying the IPS location on the graphical user interface, determining a level of accuracy of the IPS location, and when the level of accuracy is not adequate, determining, by a visual positioning system (VPS), a VPS location of the user device within the facility, adjusting the IPS location to a VPS-adjusted IPS location, displaying the VPS-adjusted IPS location on the graphical user interface, and monitoring for state changes; and when the level of accuracy is adequate, continuing to monitor the level of accuracy.

The VPS may determine the VPS location of the user device using a camera on the user device.

The request for determining a location of the user device within the facility may also include a request for directions within the facility, wherein the IPS provides directions to the destination, and wherein the directions are adjusted when a VPS location is determined.

A real-time location of the user device may be monitored by the IPS and displayed on the graphical user interface, wherein the IPS location continues to be adjusted based on the VPS location until a state change is identified.

The state change may comprise a change of floor level.

The change of floor level may be determined by at least one of tracking changes in altitude, detecting that the user device moved through a floor change connection, and receiving a new floor level value from the IPS.

When a state change is identified the VPS location is cleared and the VPS-adjusted IPS location reverts to the IPS location determined solely by the IPS.

The level of accuracy may be determined based on at least one of a calculated accuracy distance of the IPS location, an unknown status of a floor level for the IPS location, or the IPS location being in an area with known accuracy issues.

The known accuracy issues may be determined from analysis of test data.

The IPS location may be displayed on the graphical user interface as an IPS icon.

The VPS location may be displayed on the graphical user interface as a VPS icon.

The IPS may provide a heading using a compass.

The VPS may provide a heading.

Other aspects and features will become apparent to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a block diagram, describing a system for use with the hybrid positioning system, according to an embodiment;

FIG. 2A is a block diagram of a workflow for a hybrid indoor positioning system using both indoor positioning system (IPS) and visual positioning system (VPS), according to an embodiment;

FIG. 2B is a block diagram of the possible triggers for an inaccurate IPS in FIG. 1A, according to an embodiment;

FIG. 2C is a block diagram of a sub-workflow for adjusting the IPS based on the VPS, when the IPS does not provide a heading, according to an embodiment;

FIG. 2D is a block diagram of a sub-workflow for adjusting the IPS based on the VPS, when the IPS provides a heading, according to an embodiment;

FIG. 2E is a block diagram of a sub-workflow of monitoring for state changes as shown in FIG. 1A, according to an embodiment;

FIG. 3A is an example user interface, on a user device, of a wayfinding application using a hybrid positioning system, according to an embodiment;

FIG. 3B is an example user interface, on the user device of FIG. 2A, wherein the user has selected a destination, according to an embodiment;

FIG. 3C is an example user interface, on the user device of FIG. 2A, wherein the use is prompted to use a VPS system to refine their location, according to an embodiment;

FIG. 3D-F are example user interfaces, on the user device of FIG. 2A, wherein the user is prompted to move their camera to refine their location, according to an embodiment;

FIG. 3G is an example user interface, on the user device of FIG. 2A, wherein the direction have been adjusted based on the VPS refinement, according to an embodiment; and

FIG. 4 is a flow diagram of a method of using a hybrid indoor positioning system, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems and methods described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud-based program or system, laptop computer, personal data assistance, cellular telephone, smartphone, or tablet device.

Each program is preferably implemented in a high-level procedural or object oriented programming and/or scripting language to communicate with a computer system. However, the programs can be implemented in assembly or machine language, if desired. In any case, the language may be a compiled or interpreted language. Each such computer program is preferably stored on a storage medium or a device readable by a general or special purpose programmable computer for configuring and operating the computer when the storage media or device is read by the computer to perform the procedures described herein.

A description of an embodiment with several components in communication with each other does not imply that all such components are required. On the contrary a variety of optional components are described to illustrate the wide variety of possible embodiments of the present invention.

Further, although process steps, method steps, algorithms, or the like may be described (in the disclosure and/or in the claims) in a sequential order, such processes, methods, and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

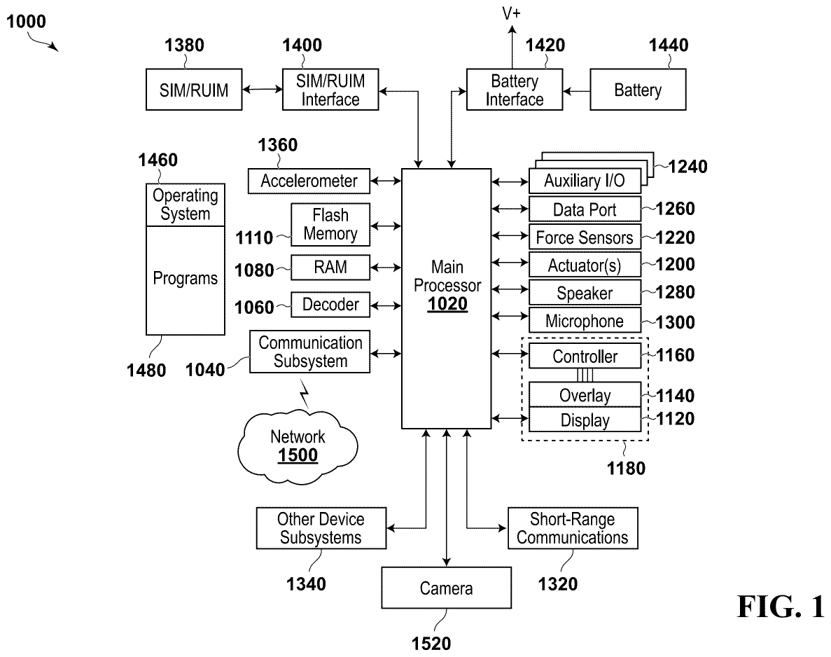

Referring to FIG. 1, shown therein is a block diagram, describing a computing system for use with the hybrid positioning system, according to an embodiment.

FIG. 1 shows a simplified block diagram of components of a device 1000, such as a mobile device or portable electronic device. Device 1000 may be utilized for a hybrid indoor positioning system as described below. The device 1000 includes multiple components such as a processor 1020 that controls the operations of the device 1000. Communication functions, including data communications, voice communications, or both may be performed through a communication subsystem 1040. Data received by the device 1000 may be decompressed and decrypted by a decoder 1060. The communication subsystem 1040 may receive messages from and send messages to a wireless network 1500.

The wireless network 1500 may be any type of wireless network, including, but not limited to, data-centric wireless networks, voice-centric wireless networks, and dual-mode networks that support both voice and data communications.

The device 1000 may be a battery-powered device and as shown includes a battery interface 1420 for receiving one or more rechargeable batteries 1440.

The processor 1020 also interacts with additional subsystems such as a Random Access Memory (RAM) 1080, a flash memory 1100, a display 1120 (e.g. with a touch-sensitive overlay 1140 connected to an electronic controller 1160 that together comprise a touch-sensitive display 1180), an actuator assembly 1200, one or more optional force sensors 1220, an auxiliary input/output (I/O) subsystem 1240, a data port 1260, a speaker 1280, a microphone 1300, short-range communications systems 1320 and other device subsystems 1340.

In some embodiments, user-interaction with the graphical user interface may be performed through the touch-sensitive overlay 1140. The processor 1020 may interact with the touch-sensitive overlay 1140 via the electronic controller 1160. Information, such as text, characters, symbols, images, icons, and other items that may be displayed or rendered on a portable electronic device generated by the processor 102 may be displayed on the touch-sensitive display 118.

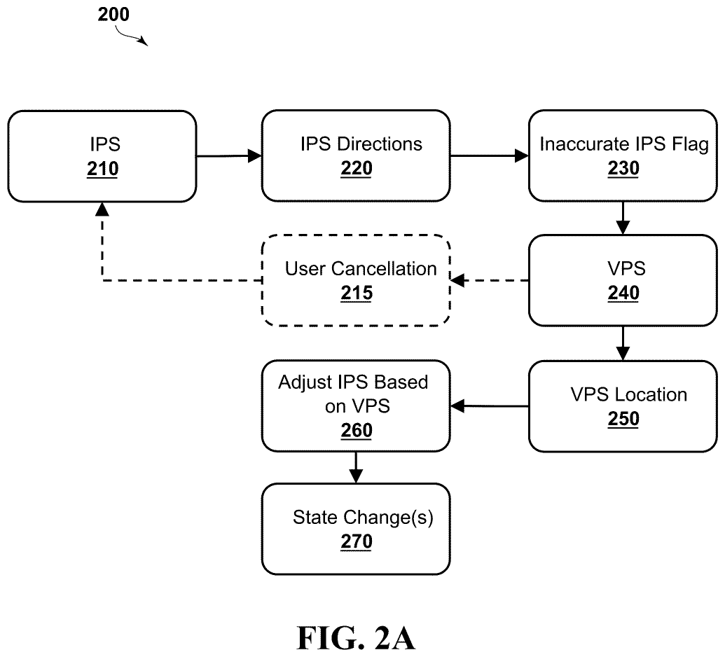

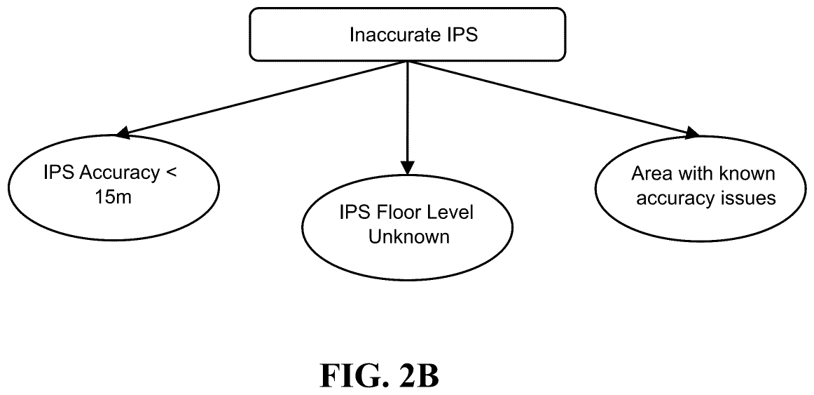

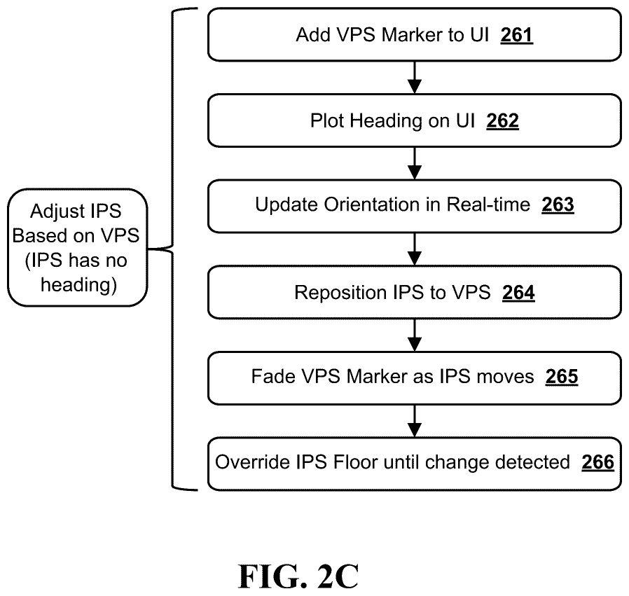

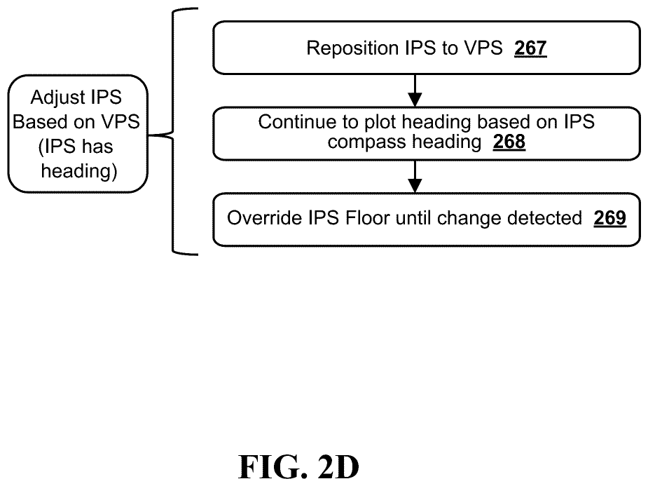

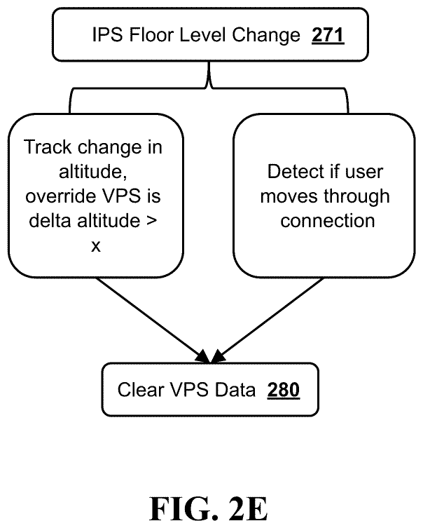

The processor 1020 may also interact with an accelerometer 1360 as shown in FIG. 2. The accelerometer 1360 may be utilized for detecting direction of gravitational forces or gravity-induced reaction forces.

To identify a subscriber for network access according to the present embodiment, the device 1000 may use a Subscriber Identity Module or a Removable User Identity Module (SIM/RUIM) card 1380 inserted into a SIM/RUIM interface 1400 for communication with a network (such as the wireless network 1500). Alternatively, user identification information may be programmed into the flash memory 1100 or performed using other techniques.

The device 1000 also includes an operating system 1460 and software components 1480 that are executed by the processor 1020 and which may be stored in a persistent data storage device such as the flash memory 1100. Additional applications may be loaded onto the device 1000 through the wireless network 1500, the auxiliary I/O subsystem 1240, the data port 1260, the short-range communications subsystem 1320, or any other suitable device subsystem 1340.

For example, in use, a received signal such as a text message, an e-mail message, web page download, or other data may be processed by the communication subsystem 1040 and input to the processor 1020. The processor 1020 then processes the received signal for output to the display 1120 or alternatively to the auxiliary I/O subsystem 1240. A subscriber may also compose data items, such as e-mail messages, for example, which may be transmitted over the wireless network 1500 through the communication subsystem 1040.

For voice communications, the overall operation of the portable electronic device 1000 may be similar. The speaker 1280 may output audible information converted from electrical signals, and the microphone 1300 may convert audible information into electrical signals for processing.

The device 1000 also includes a camera and camera operating instructions for, at least, capturing images of a location for use in VPS.

FIG. 2A is a block diagram of a workflow 200 for a hybrid indoor positioning system using both an indoor positioning system (IPS) and a visual positioning system (VPS), according to an embodiment.

The hybrid indoor positioning system is employed by a user with a device, for example device 1000 from FIG. 1. The hybrid positioning system may be run through an application programming interface (API) on the user device. The hybrid positioning system may be run through a standard application for the operating system of the user device, through a web application, or through a third party application which is downloaded to the device by the user.

The user device includes a IPS 210, which is integrated with the operating system and hardware of the user device to receive sensor data from a variety of sensors of the user device, including GPS, Wi-Fi, Bluetooth™, gyroscopes, compasses, etc. Data from the IPS is used to determine a position of the user device and a user interface is generated which shows the user position within a map of the present location. The map may be pre-loaded into the application or data may be downloaded from a web application or other source for the determined location of the user device. That is, the hybrid indoor positioning system may be part of an application that is specific to at least one location, for example, an application for navigating an airport, or the hybrid indoor positioning system may be a general positioning application for multiple different locations wherein data for the present location is pulled from an off-device, off-application memory to generate the user interface showing a map of the location.

The IPS 210 receives a request from the user to provide a location or directions on a user interface. The request may be merely opening an application, wherein the act of opening the application prompts the IPS to provide a location and for a user interface to be generated showing the determined present location of the user/user device on a map. The request may include a query for directions to a specific location or general location, e.g., the user may ask for directions to a specific terminal within an airport, or for directions to a coffee shop.

When the user inputs a request for directions, IPS directions 220 are provided on the user interface. The directions may be shown as arrows or other markings on the map, the current location of the user device may be shown as a dot or other icon.

During use of the hybrid indoor positioning system, the accuracy of location provided by the IPS is continually monitored. Inaccurate IPS 230 may be determined by a variety of different factors. FIG. 2B shows some possible triggers for an inaccurate IPS 230 including i) a predicted accuracy of the IPS location is less than a specific number of meters (the specific number may depend on the facility, and may be, for example, 15 m) the floor level within a facility is unknown based on the IPS, or iii) the provided IPS location is within an area known to have accuracy issues. Known accuracy issues may be determined based on analytics data from user testing of a location, for example, wherein it is known from the analytics data that even when a floor level is provided by the IPS, said floor level may be wrong. In other embodiments, the user may report that the location is inaccurate.

Returning to FIG. 2A, when an inaccurate IPS flag 230 is triggered, the hybrid indoor positioning system provides a prompt, on the user interface, for the user to enable a VPS 240. The user is prompted to open a camera API to enable the VPS to capture picture (or video) with the camera of the user device. The user may receive further prompts on the user interface of where and how to point the camera to enable the VPS to find a VPS location 250.

The VPS location 250 can then be used to adjust the IPS location, and possibly the IPS directions 220, to provide more accurate directions for the user.

FIG. 2C shows an example method for adjusting the IPS based on the VPS, when the IPS does not have a heading.

At 261, a VPS marker or icon is added to the user interface on the user device. The marker may be the same as the IPS position marker, or may be different.

At 262, a heading or bearing, i.e., the direction the user is facing based on the images captured by the VPS, is plotted onto the user interface. The heading may enable a user to properly determine which direction to head in when following directions to another location.

At 263, the orientation and position of the user device are updated in real-time as long as the VPS is receiving real-time images.

At 264, the IPS is repositioned to the VPS location. That is, the IPS receives the location data and uses that data to continue to calculate the location of the user device and any directions which were requested based on the VPS location.

At 265, the VPS marker which was added to the user interface fades away or is otherwise removed as the user device move away from the determined VPS location.

At 266, the IPS location continues to be locked to the VPS location data until a state change occurs. That is, any floor change or other incongruous positional changes the IPS attempts to make are overridden by the hybrid indoor positioning system until a floor change is detected.

In order to use the VPS, the facility (or other indoor location) must have been scanned or otherwise captured to generate image data in some form which can be compared to the images captured by the user device. For example, an entire airport may be scanned to generate a data point cloud which can be compared to the captured images.

In some embodiments, the entire data point cloud of a location may be downloaded or otherwise accessed for use by the VPS, while in other embodiments, the information provided by the IPS (although possibly inaccurate) may be used to limit the amount of data which needs to be accessed by the VPS.

The steps of determining the location based on the scanned facility data may occur on a back end server of a computing system and not on the user device. The hybrid indoor positioning system may use a Webapp, wherein the data processing steps also occur on a back end server.

Returning now to FIG. 2A, after the VPS location 250 is found, the IPS 210 continues to monitor the location of the user device, with the location of the user device being moved on the map based on data received from the IPS. However, until there is a state change 270, the IPS will continue to provide a location and directions based on the information provided by the VPS 240. That is, for example, if the VPS location 250 is on a specific floor, the IPS 210 will lock the location of the user device to the specific floor until there is sufficient data to suggest that the user device has changed floors.

Additionally, following the adjustment of the IPS location and directions 220 based on the VPS location 250, the accuracy of the IPS location and directions continues to be monitored, wherein another inaccurate IPS flag 230 would result in another prompt to enable VPS 240 to provide a more accurate position.

Alternatively, FIG. 2D shows an example method for adjusting the IPS based on the VPS, when the IPS has a heading provided from a compass of the user device.

In FIG. 2D, as in FIG. 2C, the location determined by the IPS has been determined or predicted to be inaccurate 230 and the user has elected to use VPS 240 to determine a more accurate VPS location 250.

In FIG. 2D, a heading provided by the IPS would be shown with the IPS marker on user interface of the user device.

At 267, the location of the IPS marker is adjusted based on the determined VPS location 250. An icon to show the determined VPS location 250 may or may not be shown on the user interface.

At 268, the heading determined by the compass continues to be displayed on the user interface.

At 269, the IPS location continues to be locked to the VPS location data until a state change occurs. That is, any floor change or other incongruous positional changes the IPS attempts to make are overridden by the hybrid indoor positioning system until a floor change is detected.

FIG. 2E shows examples of data which suggest a state change, specifically a floor level change as detected by the IPS, has occurred. The IPS floor level change 271 may be detected by either i) tracking a change in altitude and overriding the VPS is the delta for altitude is greater than a threshold value, x, ii) detecting that a user has moved through a connection, e.g., an escalator, a stairwell, etc., or iii) receiving a new floor level from the IPS, i.e., where the IPS was previously null but is now returning a value, or where the value has changed (e.g. the value was 2 but is now 1). When a floor level change has occurred based on at least one of the criteria, the data provided by VPS 240 is cleared 280 and is no longer used to adjust the position provided by IPS 210.

Returning now to FIG. 2A, when an inaccurate IPS flag 230 occurs and the user is prompted to enable VPS 240, the user may choose a user cancellation 215 instead, wherein the system continues to only use IPS 210 to provide a current position and directions to the user device.

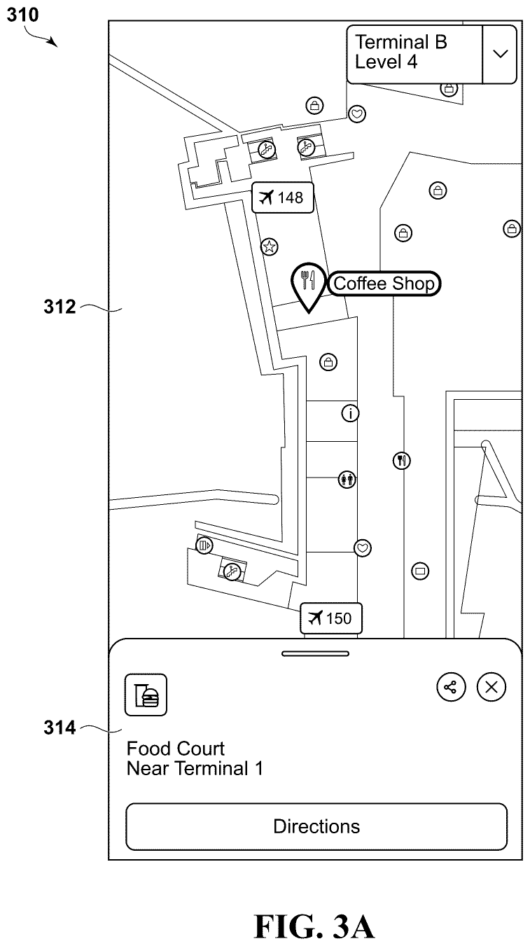

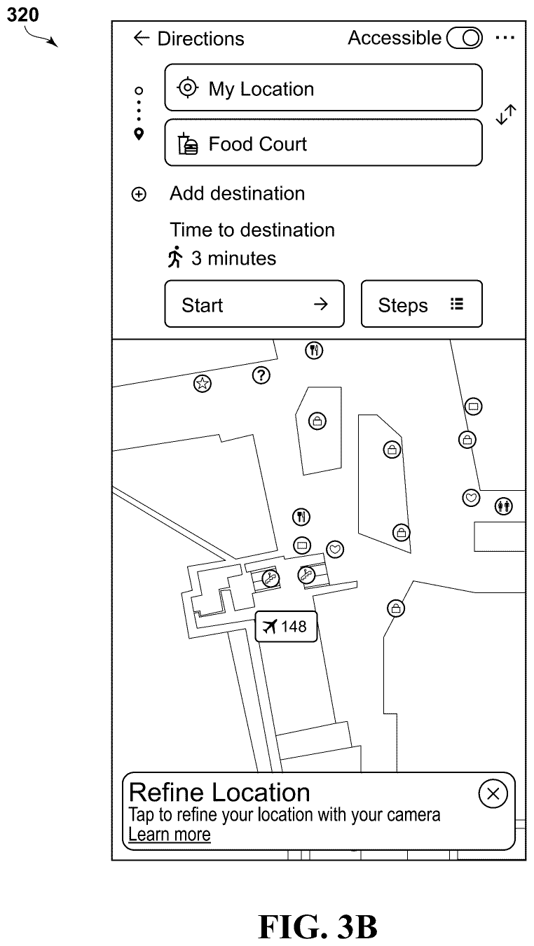

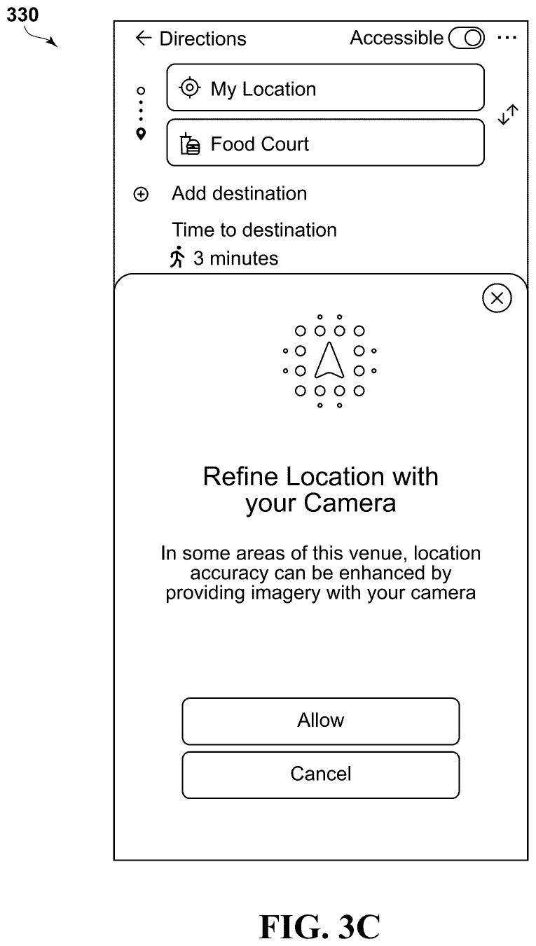

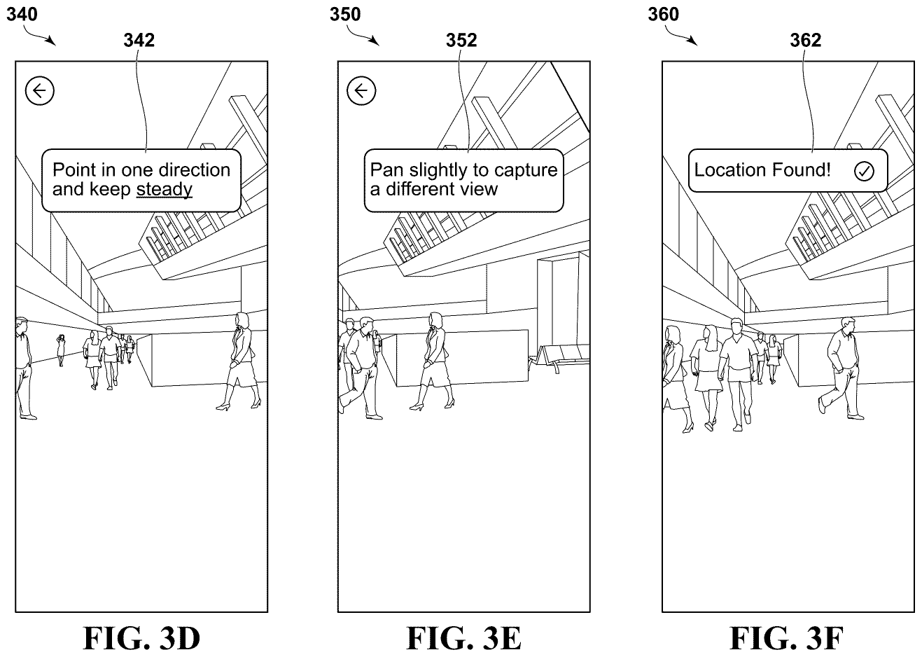

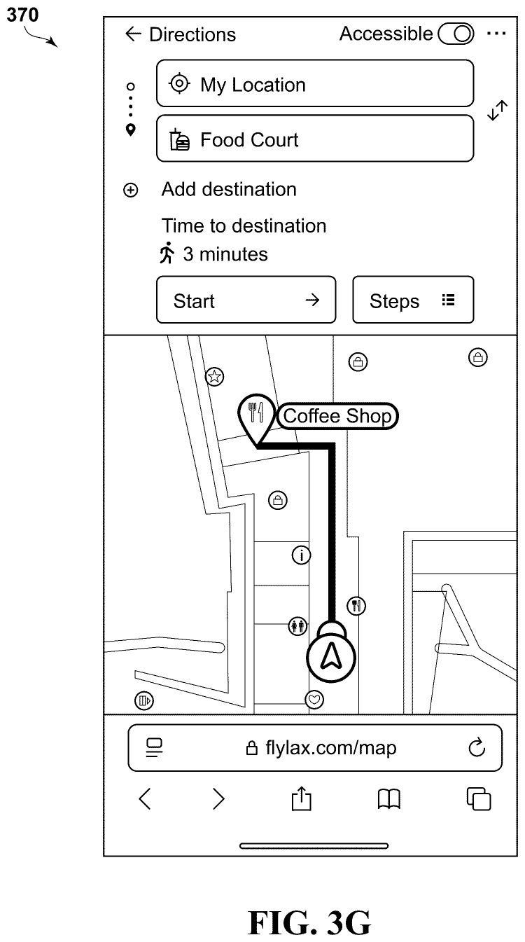

FIG. 3A is an example graphical user interface (GUI) 310, on a user device, of a wayfinding application using a hybrid indoor positioning system. The GUI 310 may be shown on a screen of a smartphone or other similar device. The GUI 301 may be a graphical user interface of a wayfinding application and shows a map 312 of a facility, in FIG. 3A an airport food court. The GUI 310 includes a drop-down menu 314 for choosing to view a map of a location within a facility which enables a user of the user device to choose where they would like to go. The GUI 310 also includes a “directions” button at the bottom to enable the user to request directions to a specific location.

The IPS location is marked by a blue dot which provides real-time location of the user device. The larger blue circle around the blue dot represents the location accuracy, with a smaller diameter representing a more accurate location. The blue dot does not provide any indication of the direction the user is currently facing. The GUI 310 includes an “N” to denote north, but the usefulness of the feature relies on the directional capabilities of the user.

FIG. 3B shows a GUI 320 which represents a graphical user interface on the user device after a request has been received to provide directions to the Food Court. The GUI 320 represents the appearance of the screen of the user device following a request for directions. The GUI 320 has fields for the starting location (set to “My location” or the current location of the user device), and a destination (the Food Court). The GUI 320 provides the option to add a destination. The GUI 320 provides an estimate of the time it will take the user to get to the destination by walking. The GUI 320 includes a “start” button to enable the user to begin the receiving direction.

The GUI 320 includes a map of the facility with a marker showing the location of the user device as determined by an IPS with a line showing the path the user should follow to arrive at their destination. In FIG. 3B, the GUI 320 includes a VPS prompt or notification that the user could refine their location (increase the accuracy of their location within the wayfinding application) by using their camera.

FIG. 3C shows a GUI 330 which represents a graphical user interface on the user device when the user has clicked on the VPS prompt and a pop-up has opened to request permission for the wayfinding app to access the camera of the user device. The user can click an “allow” button to enable the use of the camera for VPS positioning or a “cancel” button to continue using only IPS positioning.

FIG. 3D-F are example GUIs 340, 350, and 360, respectively, which represent images of the surroundings of the user device (and user) as captured by the camera of the user device, with overlaid prompts for how to move the camera.

In FIG. 3D, the user is being prompted, by prompt 342 on GUI 340, to point the user device camera in one direction and keep the camera steady. There is a progress bar at the bottom of the prompt 342 indicating how long the user must maintain the position of the user device.

In FIG. 3E, the user is prompted, by prompt 352 on GUI 350, to pan the camera slightly to capture a different view of their surroundings. As in FIG. 3D, there is a progress bar at the bottom of prompt 352 which indicates whether sufficient images have been captured to enable finding the VPS location.

In FIG. 3F, a prompt 362 on GUI 360 indicates that the VPS has successfully found a VPS location.

FIG. 3G shows a GUI 370 which represents a graphical user interface wherein the IPS location and directions have been adjusted based on the VPS location. The VPS location has been marked on the GUI 370 by an arrow inside a circle. The IPS location is marked by a blue dot, as in FIG. 3B. As the user device moves, the VPS marker will maintain the starting position while the IPS marker moves with the user device.

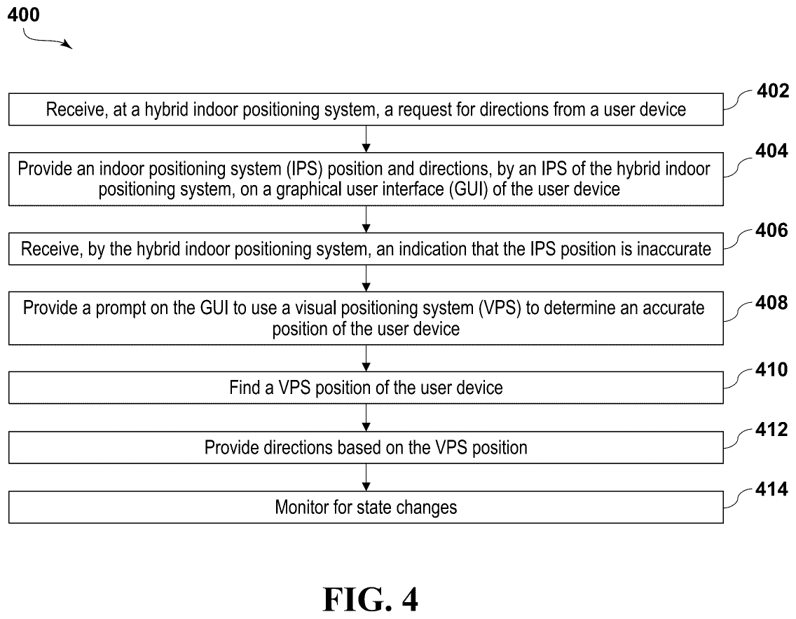

FIG. 4 is a flow diagram of a method 400 of using a hybrid indoor positioning system, according to an embodiment. The method is similar to the systems and methods described above for FIGS. 1-3G, and the user devices and graphical user interfaces of FIGS. 1-3G may be used within method 400.

At 402, a request for providing directions is received by a hybrid indoor positioning system from a user device. The hybrid positioning system may be an application on the user device, wherein a user provides an input through a graphical user interface (GUI) of the hybrid positioning system on the user device.

The request input to the user device may be a selection on a map, may be chosen from a drop-down menu of locations, or may be searched for by keywords in a search bar. Other methods of inputting a request are also contemplated.

At 404, the hybrid indoor positioning system provides a current position as determined by an indoor positioning system (IPS) of the hybrid indoor positioning system as well as directions. The IPS position and the directions are shown on a map in the GUI on the user device.

Alternatively, before 402 (i.e., before a request is received), the GUI of the hybrid positioning system may provide a current position of the user device on a map of the facility or other type of indoor area in which the user device is located (or at least assumed to be located based on IPS sensor data). The IPS position may be shown with an icon specific to an IPS-determined position. As the user device moves within the facility the icon will move on the map as well. The icon may be within a circle, the size of which indicates the accuracy of the IPS position.

At 406, the hybrid positioning system receives an indication that the IPS position is inaccurate. Such indication may include i) a predicted accuracy of the IPS location is less than 15 meters ii) the floor level within a facility is unknown based on the IPS, or iii) the provided IPS location is within an area known to have accuracy issues. Any other type of indication of inaccuracy is also contemplated.

At 408, after receiving an indication of IPS position inaccuracy, the hybrid positioning system will show a prompt on the GUI for the user to opt to use a visual positioning system (VPS) to obtain an accurate position.

At 410, if the user chooses to use the VPS, they will be prompted to follow directions using a camera on the user device to capture images to obtain a VPS position.

At 412, the hybrid indoor positioning system updates the GUI and directions based on the VPS position. The GUI may show the VPS position with an icon different from an IPS position icon. As the user device moves away from the found VPS position, the VPS icon may fade away, and the real-time location of the user device may be shown with an IPS icon. The real-time location of the user device is determined by the IPS with the IPS location locked to the floor provided by the VPS position.

At 414, the hybrid positioning system monitors for state changes which may indicate that the IPS position is no longer accurate and that the user should again use the VPS to determine an accurate position. Such states changes may include changes in altitude over a specific threshold distance, detections that a user moved through a connection, e.g., a stairwell or an elevator, or receiving a new or different floor level as determined by the IPS. When such a state change occurs the VPS position data is cleared from the hybrid positioning system.

While the above description provides examples of one or more apparatus, methods, or systems, it will be appreciated that other apparatuses, methods, or systems may be within the scope of the claims as interpreted by one of skill in the art.

1. A computer system for hybrid indoor positioning, the system comprising: at least one processor and at least one memory having stored thereon instructions that, upon execution, cause the system to perform functions comprising:
receiving, through a graphical user interface of a user device, a request for determining a location of the user device within a facility;
determining, by an indoor positioning system (IPS), an IPS location of the user device within the facility, wherein the IPS receives a map of the facility from the at least one memory;
displaying the IPS location on the graphical user interface;
determining a level of accuracy of the IPS location;
when the level of accuracy is not adequate, determining, by a visual positioning system (VPS), a VPS location of the user device within the facility, adjusting the IPS location to a VPS-adjusted IPS location, and displaying the VPS-adjusted IPS location on the graphical user interface; and
when the level of accuracy is adequate, continuing to monitor the level of accuracy.

2. The system of claim 1, wherein the VPS determines the VPS location of the user device using a camera on the user device.

3. The system of claim 1, wherein the user device further requests directions to a destination within the facility, wherein the IPS provides directions to the destination, and wherein the directions are adjusted when a VPS location is determined.

4. The system of claim 3, wherein the real-time location of the user device is monitored by the IPS and displayed on the graphical user interface, wherein the IPS location continues to be adjusted based on the VPS location until a state change is identified.

5. The system of claim 4 wherein the state change comprises a change of floor level.

6. The system of claim 5 wherein the change in floor level is determined by at least one of: tracking changes in altitude, detecting that the user device moved through a floor change connection, or receiving a new floor level value from the IPS.

7. The system of claim 4 wherein when a state change is identified the VPS location is cleared and the VPS-adjusted IPS location reverts to the IPS location determined solely by the IPS.

8. The system of claim 1, wherein the level of accuracy is determined based on at least one of a calculated accuracy distance of the IPS location, an unknown status of a floor level for the IPS location, or the IPS location being in an area with known accuracy issues.

9. The system of claim 7 wherein the known accuracy issues are determined from analysis of test data.

10. The system of claim 1, wherein the IPS location is displayed on the graphical user interface as an IPS icon.

11. The system of claim 1, wherein the VPS location is displayed on the graphical user interface as a VPS icon.

12. A method for hybrid indoor positioning, the method comprising:
receiving, through a graphical user interface of a user device, a request for determining a location of the user device within a facility;
determining, by an indoor positioning system (IPS), an IPS location of the user device within the facility, wherein the IPS receives a map of the facility from the at least one memory;
displaying the IPS location on the graphical user interface;
determining a level of accuracy of the IPS location;
when the level of accuracy is not adequate, determining, by a visual positioning system (VPS), a VPS location of the user device within the facility, adjusting the IPS location to a VPS-adjusted IPS location, displaying the VPS-adjusted IPS location on the graphical user interface, and monitoring for state changes; and
when the level of accuracy is adequate, continuing to monitor the level of accuracy.

13. The method of claim 12, wherein the VPS determines the VPS location of the user device using a camera on the user device.

14. The method of claim 12, wherein the request for determining a location of the user device within the facility also includes a request for directions within the facility, wherein the IPS provides directions to the destination, and wherein the directions are adjusted when a VPS location is determined.

15. The method of claim 14, wherein the real-time location of the user device is monitored by the IPS and displayed on the graphical user interface, wherein the IPS location continues to be adjusted based on the VPS location until a state change is identified.

16. The method of claim 15 wherein the state change comprises a change of floor level.

17. The method of claim 16 wherein the change of floor level is determined by at least one of: tracking changes in altitude, detecting that the user device moved through a floor change connection, and receiving a new floor level value from the IPS.

18. The method of claim 15 wherein when the state change is identified the VPS location is cleared and the VPS-adjusted IPS location reverts to the IPS location determined solely by the IPS.

19. The method of claim 12, wherein the level of accuracy is determined based on at least one of a calculated accuracy distance of the IPS location, an unknown status of a floor level for the IPS location, or the IPS location being in an area with known accuracy issues.

20. The method of claim 19, wherein the known accuracy issues are determined from analysis of test data.
